(19) United States
(12) Patent Application Publication
(10) Pub. No.: US 2024/0239307 A1
(43) Pub. Date: Jul. 18, 2024

(54) SYSTEM AND METHOD FOR SENSOR CLEANING AND POSITIONING

(71) Applicant: TuSimple, Inc., San Diego, CA (US)

(72) Inventor: Juexiao NING, Tucson, AZ (US)

(21) Appl. No.: 18/410,661

(22) Filed: Jan. 11, 2024

Related U.S. Application Data
(60) Provisional application No. 63/479,659, filed on Jan. 12, 2023.

(51) Int. Cl. B60S 1/56; G01S 7/40; G01S 13/931

(52) U.S. Cl. CPC B60S 1/56; G01S 7/4043; G01S 13/931; B60S 1/52; G01S 2013/9323; G01S 2013/93274

(57) ABSTRACT

Provided herein is a system and method for sensor cleaning and positioning of the sensor on a vehicle. A system can include a mount attached to a vehicle; a sensor base; a sensor supported on the sensor base; a boom connecting the mount to the sensor base; and a tether, where the tether is connected at a first end, at least indirectly, to the sensor, and at a second end to a structure within the vehicle. The system may include a sensor cleaning array of nozzles, where combined spray patterns of the array of nozzles cover a sensor window of the sensor about a field-of-view of the sensor.

### CROSS-REFERENCE TO RELATED APPLICATIONS

This application claims priority to U.S. Provisional Application Ser. No. 63/479,659, filed on Jan. 12, 2023, the contents of which are hereby incorporated by reference in their entirety.

### TECHNOLOGICAL FIELD

An example embodiment of the present disclosure relates generally to the use of sensors for vehicle navigation, and more particularly, to a system and method for sensor cleaning and positioning of the sensor on a vehicle.

### BACKGROUND

Autonomous and semi-autonomous vehicle control relies upon accurate digital maps and accurate understanding of the environment of a vehicle. A wide array of sensors are often used for autonomous and semi-autonomous vehicle control. Sensors that determine vehicle operating conditions, sensors that determine navigational directions, and sensors that identify the environment around the vehicle.

Maintaining the accuracy and effectiveness of sensors is critical to the proper function of the sensors, and to the information that the sensors provide to the vehicle for operation and for autonomous control. Positioning a sensor is not a trivial challenge, as sensors, particularly sensors relying on line-of-sight from the sensor, benefit from positioning that improves the field-of-view. Such positions can be vulnerable to impact damage from road debris and objects within an environment such that care must be exercised when positioning sensors on a vehicle.

Beyond positioning of a sensor, maintaining a sensor in good working condition is imperative for proper functionality. Line-of-sight sensors can become obstructed with dirt, snow, debris, or the like. Further, positioning a sensor in a highly-visible location to maximize the field-of-view can render the sensors vulnerable to dirt, debris, and objects such as bugs that can obstruct the field-of-view.

### BRIEF SUMMARY

A system and method are therefore provided for sensor cleaning and positioning of the sensor on a vehicle. Embodiments of the present disclosure include a system for cleaning a sensor housing including: a sensor having a sensor window, where the sensor defines a field-of-view in a horizontal plane about the sensor; a sensor base supporting the sensor thereon; and a plurality of nozzles, where the plurality of nozzles are disposed within the sensor base, where each nozzle defines a spray pattern, and where the spray pattern from the plurality of nozzles is aimed upwardly and covers the sensor window about the field-of-view. According to some embodiments, the spray pattern for each nozzle expands as a distance from a respective nozzle increases, where the spray pattern from the plurality of nozzles covers the sensor window proximate a bottom of the sensor window about the field-of-view, and where the spray pattern from the plurality of nozzles overlaps a predetermined amount proximate a top of the sensor window about the field-of-view.

According to some embodiments, the predetermined amount of overlap proximate the top of the sensor window about the field-of-view is about one-third of a first spray pattern overlapping an adjacent spray pattern. The field-of-view of an example embodiment is between about 90-degrees and 330-degrees, where the plurality of nozzles are disposed about the sensor only about the field-of-view. The sensor base of an example embodiment includes a nozzle support and a cover, where the plurality of nozzles are received within the nozzle support, and where the nozzle support is covered by the cover. According to certain embodiments, the system includes a base plate, where the base plate is secured to the sensor and to the sensor base. The system of some embodiments includes a tube bundle, where the tube bundle includes a tube for each nozzle. The tube bundle of an example embodiment enters the sensor base through an aperture, and separates to supply each nozzle with fluid.

Embodiments provided herein include a method for cleaning a sensor housing including: supporting a sensor on a sensor base, where the sensor includes a sensor window and defines a field-of-view in a horizontal plane about the sensor; and spraying the sensor window with a spray pattern from each of a plurality of nozzles, where the spray pattern from the plurality of nozzles is aimed upwardly from the sensor base and covers the sensor window about the field-of-view. According to some embodiments, the spray pattern from the plurality of nozzles covers the sensor window about the field-of-view proximate a bottom of the sensor window, the method further including configuring the spray pattern from adjacent nozzles of the plurality of nozzles to overlap by a predetermined amount proximate a top of the sensor window about the field-of-view.

According to certain embodiments, the predetermined amount of overlap proximate the top of the sensor window about the field-of-view is about one-third of a first spray pattern overlapping an adjacent spray pattern. The method of some embodiments further includes spacing the plurality of nozzles around the sensor to cover the field-of-view of the sensor, where the field-of-view of the sensor is less than 330-degrees. The method of some embodiments includes: supporting the plurality of nozzles on a nozzle support, and surrounding the nozzle support with a cover. The method of some embodiments includes mounting the nozzle support and cover to a sensor base. The method of certain embodiments further includes attaching the sensor to a base plate, and attaching the base plate to the sensor base. According to some embodiments, the method further includes connecting each of the plurality of nozzles with a nozzle-specific tube of a tube bundle, where the tube bundle enters the sensor base through an aperture.

Embodiments provided herein include an apparatus for cleaning a sensor housing including: a sensor base including: a base frame; a nozzle support carried by the base frame; a plurality of nozzles received within the nozzle support; and a cover supported by the base frame and covering the nozzle support; and a sensor supported by the sensor base, where the sensor includes a sensor window, where the sensor defines a field-of-view in a horizontal plane about the sensor, and where spray patterns from the plurality of nozzles are aimed upwardly and cover the sensor window about the field-of-view. The plurality of nozzles are, in some embodiments, disposed about a base of the sensor, and the plurality of nozzles are within a distance of the sensor that is less than a radius of the sensor. According to some embodiments, a top of each of the plurality of nozzles is disposed below a bottom of the sensor.

Embodiments provided herein include a system for supporting a sensor on a vehicle including: a mount attached to a vehicle; a sensor base; a sensor supported on the sensor base; a boom connecting the mount to the sensor base; and a tether, where the tether is connected at a first end, at least indirectly, to the sensor, and at a second end to a structure within the vehicle. According to some embodiments, the sensor includes an indicator light within the sensor base, where the indicator light provides an indication of autonomous control of the vehicle. According to some embodiments, the mount is configured to attach to a substantially vertical surface, and where the sensor base provides a substantially horizontal surface on which to support the sensor.

According to some embodiments, the substantially vertical surface is a hood portion of the vehicle. According to certain embodiments, the boom extends upwardly from the mount to position the sensor above a substantially horizontal surface of the hood portion of the vehicle. The sensor base of an example embodiment includes a plurality of nozzles, where combined spray patterns of the plurality of nozzles cover a sensor window of the sensor about a field-of-view of the sensor. The sensor base of an example embodiment defines a width of no more than twice a diameter dimension of the sensor, and the plurality of nozzles are within a distance from the sensor of no more than a radius dimension of the sensor. The sensor of an example embodiment is secured to the sensor base by a base plate, and the tether is connected at a first end to the base plate.

Embodiments provided herein include a system for supporting a sensor on a vehicle including: a mount attached to a vehicle; a sensor base; a sensor supported on the sensor base; a boom connecting the mount to the sensor base; and an indicator light within the sensor base, where the indicator light provides an indication of autonomous control of the vehicle. According to some embodiments, the mount is configured to attach proximate a front of the vehicle, where the sensor is supported by a horizontal surface of the sensor base. According to certain embodiments, the mount is configured to attach to at least one of a hood of the vehicle or a fender of the vehicle. The sensor base of an example embodiment is elevated relative to the mount to a position above at least a portion of the hood of the vehicle.

According to some embodiments, the system includes a sensor cleaning array of nozzles, where combined spray patterns of the array of nozzles cover a sensor window of the sensor about a field-of-view of the sensor. According to some embodiments, the sensor cleaning array of nozzles is mounted to the sensor base, and the spray pattern of the array of nozzles is directed upwardly to impinge the sensor window of the sensor. The system of an example embodiment further includes a tether, where the sensor is secured to the sensor base by a base plate, and where the tether is connected at a first end, at least indirectly, to the sensor, and at a second end, to a structure within the vehicle.

Embodiments provided herein include a method for supporting a sensor on a vehicle including: attaching a mount to a vehicle; supporting a sensor on a sensor base; connecting the mount to the sensor base by a boom; and connecting a tether, at a first end, at least indirectly to the sensor, and at a second end to a structure within the vehicle. According to some embodiments, the method includes providing an indicator light within the sensor base; and illuminating the indicator light based on an autonomous control status of the vehicle. The method of an example embodiment further includes cleaning the sensor with a plurality of nozzles disposed within the sensor base. According to some embodiments, the combined spray patterns of the plurality of nozzles cover a sensor window of the sensor about a field-of-view of the sensor. The method of an example embodiment further includes: securing the sensor to the sensor base with a base plate, and connecting the first end of the tether to the base plate.

### BRIEF DESCRIPTION OF THE DRAWINGS

Having thus described certain example embodiments of the present invention in general terms, reference will hereinafter be made to the accompanying drawings which are not necessarily drawn to scale, and wherein:

FIG. 1 illustrates a top-view of a vehicle including a sensor layout according to an example embodiment of the present disclosure;

FIG. 2 illustrates a side-view of the vehicle including a sensor layout according to an example embodiment of the present disclosure;

FIG. 3 illustrates a boom-mounted sensor according to an example embodiment of the present disclosure;

FIG. 4 illustrates a side-mounted sensor according to an example embodiment of the present disclosure;

FIG. 5 illustrates a top-view of a vehicle including a sensor layout and sensor fields-of-view according to an example embodiment of the present disclosure;

FIG. 6 illustrates an exploded view of the boom-mounted sensor according to an example embodiment of the present disclosure;

FIG. 7 illustrates an exploded view of the side-mounted sensor according to an example embodiment of the present disclosure;

FIG. 8 illustrates an exploded view of the side-mounted sensor with a plurality of cleaning nozzles according to an example embodiment of the present disclosure;

FIG. 9 illustrates spray patterns for a plurality of nozzles surrounding at least a portion of a sensor according to an example embodiment of the present disclosure;

FIG. 10 illustrates a top-view of the sensor with spray patterns for a plurality of nozzles surrounding at least a portion of the sensor according to an example embodiment of the present disclosure;

FIG. 11 illustrates a top-view of the sensor with a spray pattern from a single nozzle according to an example embodiment of the present disclosure; and

FIG. 12 illustrates a top-view of a boom-mounted sensor including a plurality of nozzles according to an example embodiment of the present disclosure.

### DETAILED DESCRIPTION

Some embodiments of the present invention will now be described more fully hereinafter with reference to the accompanying drawings, in which some, but not all, embodiments of the invention are shown. Indeed, various embodiments of the invention may be embodied in many different forms and should not be construed as limited to the embodiments set forth herein; rather, these embodiments are provided so that this disclosure will satisfy applicable legal requirements. Like reference numerals refer to like elements throughout.

Autonomous vehicle control, as described herein, includes vehicle control that is performed at least partially by a vehicle controller taking some responsibilities away from a human driver. Autonomous vehicle control can include semi-autonomous control, where certain functions are performed by a controller, while a human driver performs other functions, and fully-autonomous control, where a human driver is not necessary for control and navigation of the vehicle. Autonomous vehicle control, as described herein, includes this array of control possibilities such that the term “autonomous vehicle control” can include any degree of autonomous control ranging from minimal autonomy to fully autonomous.

Autonomous vehicle control is becoming more widely adopted, with increasing levels of autonomy becoming practical. Autonomous vehicle control is particularly beneficial for transport of goods, where such transport can occur at all hours of the day and for long distances. Although the systems and methods of example embodiments may be employed in conjunction with a variety of different types of autonomous vehicles, the systems and methods described herein will be described in conjunction with a truck, such as a tractor trailer, that is configured to operate autonomously by way of example, but not of limitation.

Vehicle sensors are often critical for operation of the vehicle. Sensors of conventional, manually-driven vehicles perform a wide range of functions, from wheel speed sensors, to rain detecting sensors, to parking sensors. Vehicles that have some degree of autonomy, whether it is adaptive cruise control, braking assist, steering assist, or total driverless autonomous control, require additional sensors, and many of these sensors are critical to the autonomous functionality of the vehicle. Sensor failures in vehicles can impair vehicle function, and when those sensors are critical to autonomous control, such sensor failure can require autonomous control to be relinquished to a human driver. It is critical to maintain vehicle sensor functionality. While certain sensors can function in a capacity-reduced state, other sensors are more sensitive to environmental conditions and adverse effects. Embodiments described herein provide a method and system for positioning vehicle sensors in an optimal position for functionality, while also providing a method and system to clean the sensors to maintain optimal functionality.

While sensor positioning and functionality is important for all autonomous vehicles, it is particularly important for large vehicles. Roadways with traffic, urban corridors, and narrow streets or rural roads pose a greater challenge to large vehicles as there is less room for error in movement to avoid contact between the large vehicle and any elements of the environment. As such, positioning of certain sensors on a large vehicle is important to optimize functionality.

Sensors that require line-of-sight are particularly sensitive to position as they function best with a clear, broad range of vision. Cameras, radar, and light distancing and ranging (LiDAR) are examples of such line-of-sight sensors that benefit from optimized positions. While embodiments of the systems and methods described herein for positioning and cleaning can be implemented with any of these line-of-sight reliant sensors, embodiments of the illustrated embodiment will herein be referenced with regard to a LiDAR sensor that can be used to facilitate autonomous vehicle control.

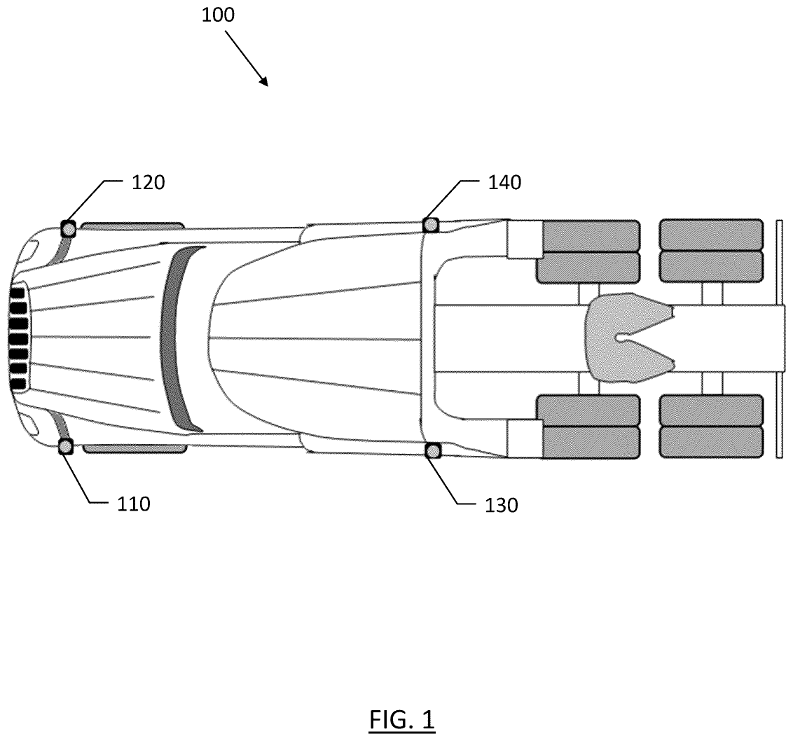

FIG. 1 illustrates a truck 100 having four line-of-sight sensors or LiDAR sensors positioned strategically on the exterior of the truck. A first hood-mounted sensor 110 is at the front-left of the truck 100, while a second hood-mounted sensor 120 is at a front-right of the truck. A first side-mounted sensor 130 is on the left side of the truck proximate a middle of a length of the truck, while a second side-mounted sensor 140 is on the right side of the truck. These positions are purposefully selected to provide the greatest amount of sensor coverage from positions that have an optimum view of the environment of the truck 100. The hood mounted sensors are, in some embodiments, mounted to a fender of the truck, positioning the sensors in a similar location proximate a front corner of the truck. While these locations are purposefully selected, sensors can be mounted in a variety of locations including more or fewer sensors to obtain a comprehensive view of the surroundings of the vehicle. Sensor positioning is generally forward-biased (toward the front of the vehicle) as the primary direction of travel of the vehicle, particularly when using the sensors for autonomous control, is in the forward direction. Thus, the positioning of the sensors shown in FIG. 1 is well-suited to autonomous vehicle control in the forward direction. Additional sensors may be required for autonomous control in the reverse direction such that the field-of-view behind the vehicle is covered.

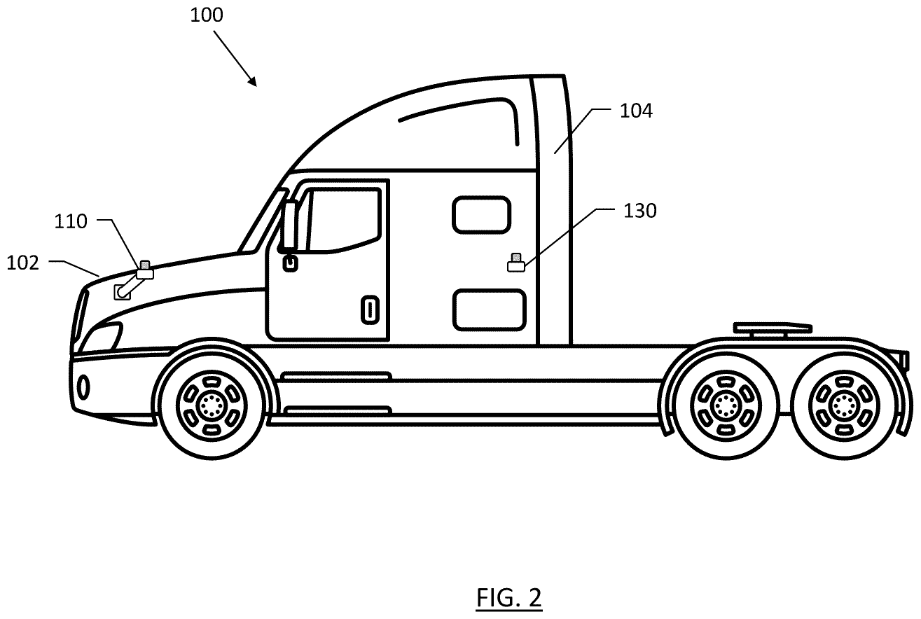

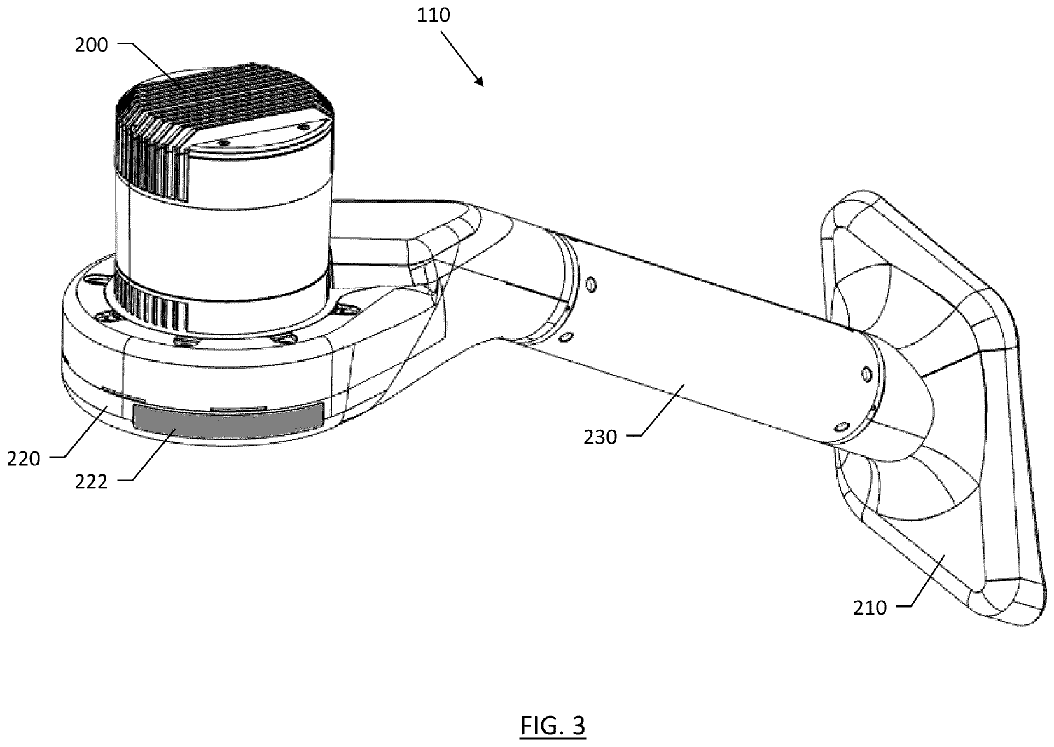

FIG. 2 illustrates a left-side view of the truck 100 of FIG. 1 including the first hood-mounted sensor 110 mounted to a hood 102 of the truck 100 and the first side-mounted sensor 130 proximate a fairing 104 of the truck. The first hood-mounted sensor 110 is shown in greater detail in FIG. 3, illustrated separate from the truck. As shown, the hood-mounted sensor includes a mount 210 which provides a mounting bracket for mounting the sensor to the truck. The mount 210 is structured to support the cantilevered sensor 200. The mount 210 can be secured to a hood, fender, or other structural element of a truck to provide positioning of the sensor 200 proximate a front corner of the truck. This position provides line-of-sight to objects in the environment in front of the truck and proximate the front corner of the truck where the sensor is mounted.

The sensor 200 is supported by a sensor base 220, where the sensor base 220 is connected to the mount 210 by boom 230. The boom 230 can be a length selected based upon the model of vehicle to which the sensor is being attached, and based on a position at which the mount 210 is being mounted. The boom 230 length can be selected based on the vehicle and the desired position of the sensor relative to the mount 210. While the illustrated embodiment depicts a straight boom 230, the boom can be curved, have an angled bend, or have any shape necessary to position the sensor base 220 in an appropriate location relative to the mount 210 based on the vehicle to which the sensor 200 is to be mounted, and a location on the vehicle where the mount 210 is to be positioned.

Optionally, the interface between the mount 210 and the boom 230, and between the sensor base 220 and the boom 230 can be configured such that rotation between the boom 230 and the mount 210 or the base 220 provides a different relative angle between the boom 230 and the mount 210 or the base 220. Such a configuration provides a universal adapter to allow the mount 210 to be mounted on surfaces that may have different relative angles to a ground plane, while enabling the sensor base 220 to be positioned such that the sensor 200 is flat relative to the ground plane. As illustrated in FIG. 2, the first hood-mounted sensor 110 is positioned to provide a line-of-sight over the hood 102 of the truck. The mount 210 of the illustrated configuration is configured to attached to a substantially vertical surface (e.g., within ten degrees of vertical) of the vehicle hood, while the boom 230 elevates the sensor base to provide visibility over a substantially horizontal surface of the hood 102 as shown in FIG. 2. If a mount 210 is positioned lower on a vehicle, such as lower on the hood, the boom 230 may be longer to raise the sensor base 220 to a sufficient height such that the sensor 200 has a line of sight over the hood. The angle of the boom 230 relative to the mount 210 may also be application-specific, positioning the sensor above a substantially horizontal surface of the hood, but maintaining the sensor base within an envelope of the vehicle footprint as viewed from above or close to such a footprint. Having the sensor base 220 extend significantly outside of a footprint of a vehicle can render the sensor 200, sensor base, and boom 230 more vulnerable to damage.

The boom 230 configuration may also be influenced by a configuration of the sensor unit. For example, if a sensor unit is relatively tall, the boom may not be needed to elevate the sensor base as much. The sensor mount 210, the boom 230, and/or the sensor base 220 may include vibration dampening features that provide some degree of stability to the sensor 200. For example, the boom 230 may not be rigid and may be able to absorb some vibrations received at the sensor mount 210 from the vehicle to mitigate the vibrations before they reach the sensor base. Materials for the sensor base, 220, the boom 230, and the mount 210 may be selected to be strong, but preferably relatively light weight. Weight is a significant consideration on vehicles as heavier vehicles suffer from degraded efficiency due. Materials can include fiber-reinforced composites, such as carbon fiber or fiberglass, or can be lightweight alloys of aluminum, magnesium, or the like.

According to some embodiments, the boom can have a profile that is more aerodynamic, having a lower drag coefficient. For example, the boom can have an airfoil shape that reduces drag. Aerodynamics can improve the efficiency of vehicles, such that reducing the drag associated with sensor mounts as described herein can be beneficial to overall fuel or energy economy of the vehicle.

The hood-mounted sensor 110 of an example embodiment further includes an indicator light 222 that can be used to communicate a status of autonomous control. Autonomous control indications are not yet mandatory or standardized; however, such requirements may be forthcoming. The indicator light 222 can use color, flashing pattern, or a combination thereof to communicate an autonomous control status to inform vehicles proximate the truck of the operation of the truck. Additionally, the indicator light 222 may be used to communicate the operating mode of an autonomous vehicle to human drivers of surrounding vehicles, as well as to pedestrians who may interact with the autonomous vehicle on a roadway, such as at an intersection. This type of communication between an autonomous vehicle and a driver of a manually operated vehicle may be useful when there is no direct communication via electronic means; the knowledge that a vehicle is being controlled by an autonomous driving system may enable a human driver to adjust his or her driving as needed to interact safely with the autonomous vehicle. Such an indicator can also optionally be used in the field of platooning of trucks, where the indicator light 222 can indicate whether the truck is part of a formed platoon, looking to join a platoon, or under cooperative autonomous control of a platoon.

Beyond the indicator light 222, the vehicle may transmit a message regarding autonomous vehicle control and/or platoon participation. This transmitted message may be in the form of a near-field communication, which may be generated by a module within the vehicle, or within the sensor base 220. The message can optionally be an audible tone that indicates the autonomous control status or platoon status. Such a tone, which may be emitted from a tone generating speaker within the sensor base, may be beneficial for pedestrians proximate the vehicle, alerting them to the autonomous nature of control of the vehicle such that an appropriate level of caution can be exercised.

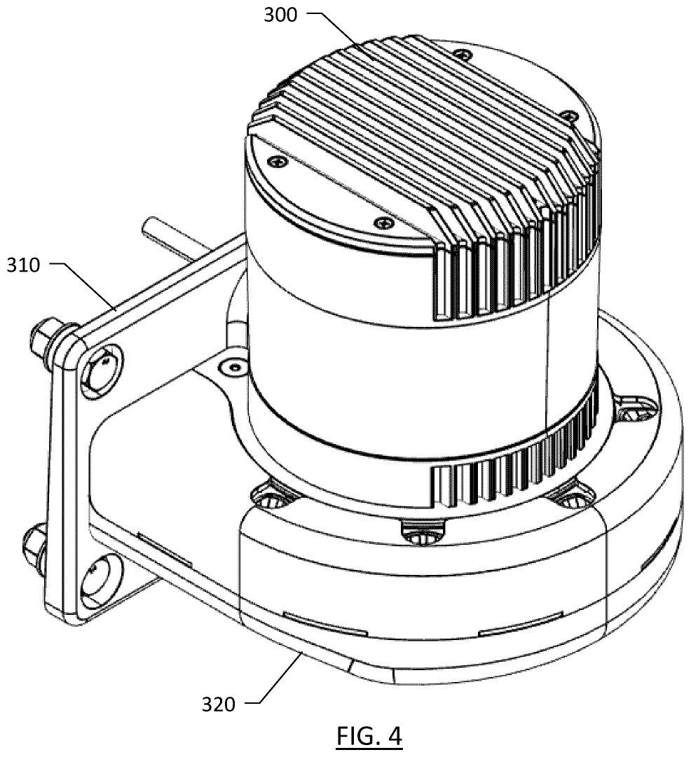

FIG. 4 illustrates an example embodiment of the side-mounted sensor 300 including mount 310 and sensor base 320. As shown, in FIG. 2, the side-mounted sensor is positioned on a side of the truck 100 at a rear portion of a cab of the truck. This positioning provides distance between the hood-mounted sensor 110 and the side-mounted sensor 130, which provides for improved stereoscopic interpretation of the environment of the truck. The location of the side-mounted sensor 130 may also provide for increased visibility in areas that are traditionally blind spots for the truck. The side-mounted sensor 130 can optionally include an indicator light, similar to the indicator light 222 of the hood-mounted embodiment described above. An indicator light on the side-mounted sensor can be used in the same manner as described above with respect to communicating autonomous vehicle control status, platoon participation status, or the like.

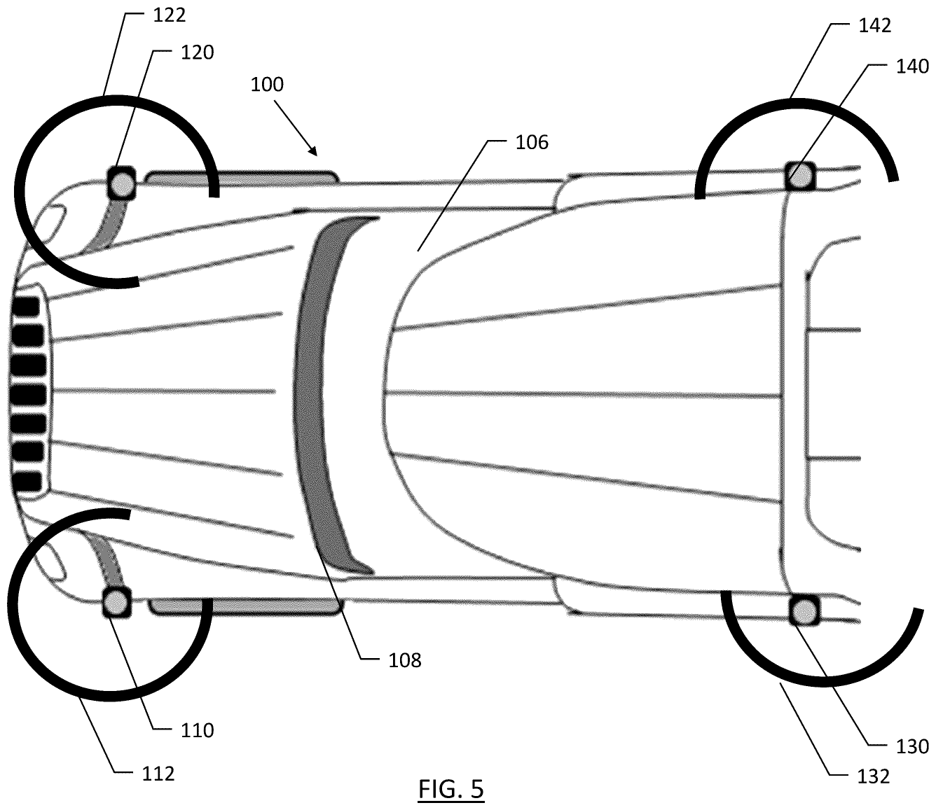

FIG. 5 illustrates an example field-of-view of sensors mounted as described above. The field of view is described in the horizontal plane that is approximately parallel to the roadway on which the vehicle is traveling. The field-of-view also extends in the vertical plane; however, embodiments described herein generally describe the field-of-view in the horizontal plane as this plane is primarily impacted by positioning of the sensors on a vehicle. As shown, the first hood-mounted sensor 110 has a first hood-mounted sensor field-of-view 112, while the second hood-mounted sensor 120 has a second hood-mounted sensor field-of-view. As the sensors are positioned at a height above the hood level directly adjacent to the sensors, the field-of-view can be up to about 330-degrees, with the obstructed portion of the field-of-view being the portion of the truck cab 106 from the windshield 108 to the fairing (104 shown in FIG. 2). The hood-mounted sensors described above can be mounted using the boom 230 and associated structure to provide both an elevated height for the sensors to obtain a line-of-sight over the hood of the vehicle, at least in part, but also to extend the sensors laterally from a body of the vehicle in order to have improved views of the environment beside the vehicle. While the primary direction of travel of the vehicle is forward and sensor views forward of the vehicle are critical, an understanding of objects such as other vehicles adjacent to the vehicle is of critical importance for maneuvers such as lane changes. Lane changes in large vehicle such as commercial trucks are challenging, particularly due to the size of the vehicles and the lack of maneuverability, such that sensor fields-of-view of from the sides of the vehicle can also be of critical importance. As such, the positioning of the sensors described herein is deliberate and provides a superior view about the vehicle to improve safety and performance.

The first side-mounted sensor 130 has a first side-mounted sensor field-of-view 132 and the second side-mounted sensor 140 has a second side-mounted sensor field-of-view. This field-of-view can be in the range of about 90-degrees to about 270-degrees. The field-of-view is influenced by the position on the cab 106 of the truck, such that if positioned at a rear corner of the truck (e.g., on the fairing 104 or on a truck without a fairing), the field-of-view can be up to 270-degrees.

The hood-mounted sensors may be subject to impact or damage by virtue of the extension of the sensor base 220 from the truck itself via the boom 230. While the mount 210, boom 230, and sensor base 220 can be constructed of robust, resilient material, some degree of damage may be experienced through impact with objects in the environment of the truck 100. A sensor mount can be made to withstand virtually any impact; however, the more impact-resistant a sensor mount is made, the heavier and/or more costly a mount becomes. Trade-offs exist between a sensor mount and resiliency. Embodiments described herein employ a relatively light-weight sensor mount to aid in overall vehicle weight minimization, while providing a mechanism by which the sensor 200 is protected from loss.

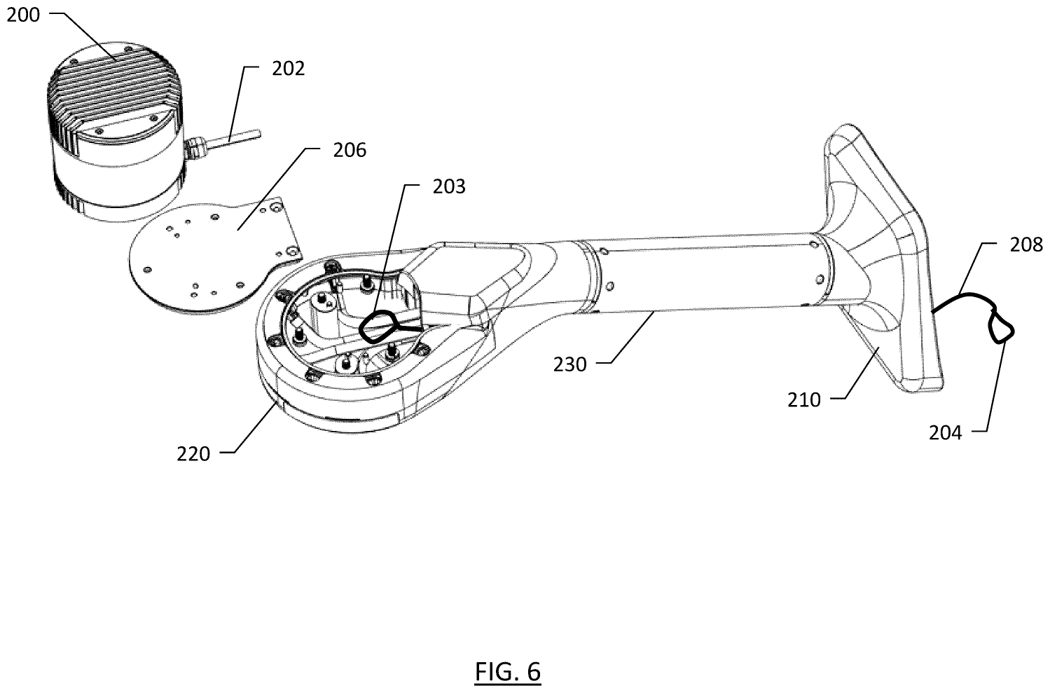

To help protect the sensor 200 from damage and loss, the sensor 200 can be tethered to an anchor mounted on the truck. A tether 208, such as a braided metal cable, can be anchored on the truck at a structurally secure location which may be within the hood 105, and connected at a distal end to the sensor 200. FIG. 6 is an exploded view of the hood-mounted sensor that illustrates an example embodiment of a tether with a sensor-end 203 of the tether 208, and a secured end 204 of the tether. The tether 208 itself can extend through the boom 230 and connect at the sensor-end 203 to the sensor 200 through an eyelet, a fastener, or the like. The sensor 200 of example embodiments can be securely mounted to a base plate 206, which in-turn connects to the sensor base 220. In such an embodiment, the sensor-end 203 of the tether can be fastened to the base plate 206 to secure the sensor 200.

In the event of a substantial impact to the sensor 200, the sensor base 220, or the boom 230, the boom and/or sensor base can break away from the mount 210, at least in part. After such an impact, the sensor 200 remains tethered to the vehicle via tether 208, such that the sensor is not lost. The boom and/or sensor base can be replaced, and the sensor 200 re-attached to the vehicle. In addition to avoiding loss of the sensor 200, the tethered sensor is precluded from becoming a projectile or debris after an impact, thereby improving safety of the boom-mounted sensor.

According to an example embodiment described herein, the sensor cable 202 can be reinforced, such as with a braided steel cable or other high-tensile strength material, such that the sensor cable 202 itself can function as a tether. In such an embodiment, a reinforced sensor cable can have the reinforced cable portion secured to a housing of the sensor (e.g., within the sensor) while a distal end (not shown) of the sensor cable is attached to a secure sensor connector within the vehicle. Such an embodiment can eliminate the need for a separate tether 208 while providing substantially the same protection to the sensor 200.

The sensors described above, as mounted to a vehicle, are subject to environmental conditions that can adversely affect their function. For example, sensors on an exterior, forward-facing portion of a vehicle are subject to precipitation, dust/dirt, bug impacts, debris, or the like. These environmental conditions can adversely affect the function of the sensors by affecting their line-of-sight. The field-of-view of a line-of-sight of a sensor can be dramatically reduced when obscured by dirt, bug debris, or the like. Embodiments of the sensor mounts described herein provide a mechanism by which the sensors are cleaned to preserve the field-of-view of the sensor to maintain optimum functionality.

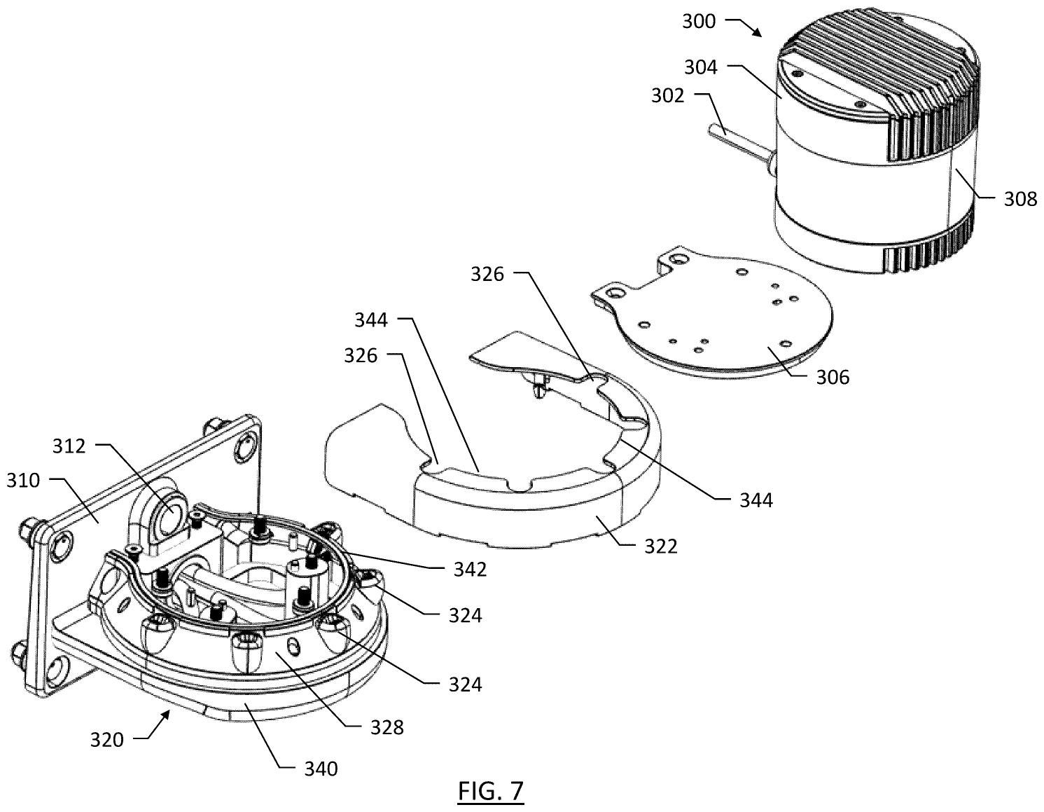

FIG. 7 illustrates an exploded view of the side-mounted sensor of example embodiments described herein. As shown, the sensor 300 is separated from the sensor base 320. The sensor 300 of the illustrated embodiment is mounted to the sensor base 320 by way of a base plate 306. The base plate 306 provides an interface for securing the sensor 300 to the base plate, and securing the base plate to the sensor base 320. This enables differing sensors and sensor fastener patterns to be adapted for attachment to the sensor base 320 without requiring a unique sensor base for each sensor fastener pattern. Further, the base plate 306 provides a structural element to which both the sensor 300 and the sensor base 320 can be secured. The sensor base 320 further includes cover 322 that covers and protects a plurality of spray nozzles 324 from debris and contact. The cover 322 includes cut-outs 326, each cut-out aligned with a spray nozzle 324. There are five spray nozzles 324 and corresponding cut-outs 326. The array of spray nozzles 324 are each individually received within nozzle base 328 which is secured to the sensor base frame 340. The cover 322 includes tabs 344 that each rest on a top rim 342 of the nozzle base 328 such that the cover 322 is securely engaged with the sensor base frame 340 and the nozzle base 328.

The sensor 300 is wired to a control system of the truck via a cable 302. This cable 302, which carries information to and from the sensor 300, is configured to pass through a grommet 312 of the mount 310 and into the truck, where the cable leads to a controller. The controller can be a sensor-specific controller, or a module of the truck, for example. The cable 302 can transmit data collected by the sensor 300 to a controller that parses the sensor data to aid in vehicle navigation, autonomous vehicle function, and data collection regarding an environment of the vehicle. The data transmitted by the sensor 300 over cable 302 can further include an indication of a condition of the sensor. For example, if the sensor window 308 is fouled, such as by dirt, bugs, liquid, or the like, the sensor data can indicate that the sensor function may be degraded and that the sensor window requires cleaning. This indication can be used to inform the cleaning system described herein, prompting cleaning nozzles to be actuated until sensor function is properly restored. If after cleaning nozzles have actuated for a predetermined time the sensor function is still communicated to be degraded, manual inspection may be prompted, such as via a user interface of the vehicle, or through an indication of the indicator light 222 (e.g., flashing a particular color or pattern of flashes).

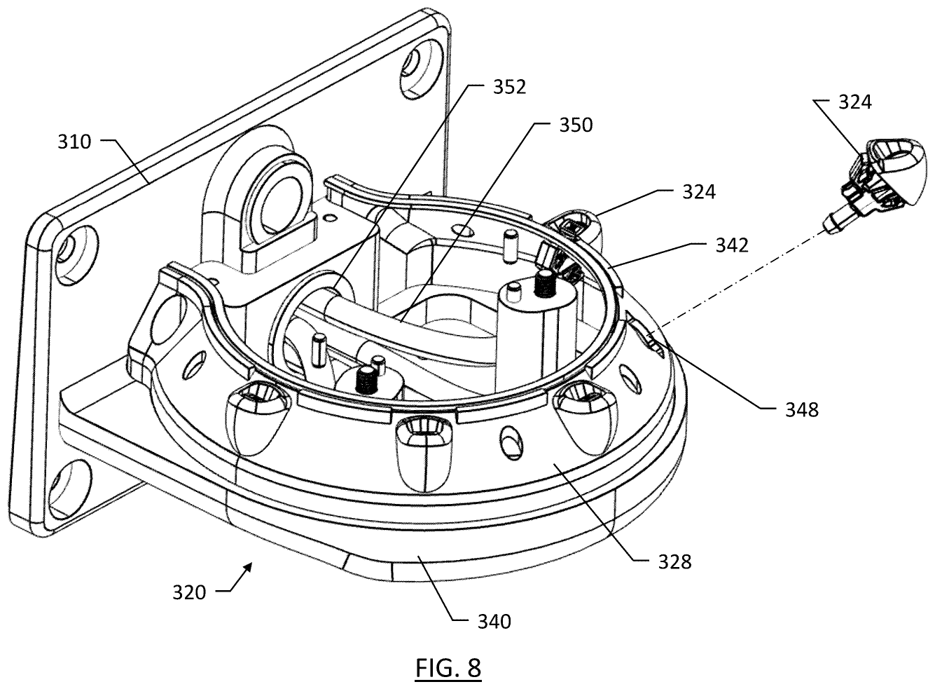

FIG. 8 illustrates a view of the sensor base 320 and mount 310 of an example embodiment without the sensor 300, cover 322, or base plate 306. As shown, a spray nozzle 324 is removed from a corresponding nozzle aperture 348. Each spray nozzle 324 is received within a corresponding nozzle aperture 348 and connected to a corresponding hose 350. The hoses 350, of which there are five in the illustrated example, form a hose bundle, which passes through aperture 352 that includes a grommet and into the truck. The hose bundle is connected to a manifold fed by a supply hose from a tank (not shown). The tank holds a supply of cleaning fluid, which may be water, windshield washing fluid (e.g., methanol-based), isopropyl alcohol, ethanol, or other fluid that does not harm the environment as the cleaning fluid will, upon use, be released to the environment (e.g., after spraying to clean the sensor).

The arrangement of nozzles 324 of the illustrated embodiment of FIGS. 7 and 8 provides nozzles around 180-degrees of the sensor 300. Depending upon the sensor mount (e.g., a hood-mounted sensor, side-mounted sensor, etc.), the number and position of nozzles can be adapted to cover the field-of-view of the sensor. The nozzles 324 of the illustrated embodiment include a specific combination of spray pattern and position about the sensor to provide adequate washing of the sensor. Too few nozzles can result in inadequate washing, while too many nozzles can result in wasted fluid or insufficient fluid pressure at the nozzles. Similarly, too wide of a spray pattern from a nozzle can result in insufficient washing power at a point of contact with the sensor, while too narrow of a spray pattern from a nozzle can result in insufficient coverage of the nozzles. Different types of nozzles with different spray patterns may require different spacing about the sensor, and may require more or fewer nozzles.

Components of the sensor cleaning system described herein can provide feedback on an adequacy of sensor cleaning based on sensor data captured by the sensor. In the event that sensor performance remains degraded after a cleaning cycle, additional cleaning cycles may be prompted. Optionally, in an embodiment with a variable speed pump, a pressure of cleaning fluid through the nozzles may be increased to provide additional cleaning to obtain optimum sensor performance.

The sensors described herein are positioned on vehicles in a fixed position relative to the vehicle, such that forward-facing sides of the sensor are more likely to be fouled by debris, bugs, dirt, fluid, etc. As such, nozzles configured to spray onto the front side of the sensor may be configured with a tighter spray pattern to produce higher pressure on the sensor window 308 as the cleaning fluid is pumped through the nozzles. Optionally, nozzle spacing around the sensor may be more concentrated proximate a front side of the sensor to improve cleaning of the forward facing side of the sensor. According to some embodiments, a proportioning valve can be used to send a higher volume and/or a higher pressure of fluid to the nozzles spraying toward a forward facing side of the sensor to bias the cleaning operation toward the front of the sensor, thereby counteracting the larger proportion of contaminants experienced by the front side of the sensor. As the nozzles 324 of the illustrated embodiment are supplied by individual hoses, the manifold from which these hoses emanate may also serve as the proportioning valve. Such a proportioning valve can be tuned to divert more cleaning fluid to the forward facing side of the sensor. Such a tunable proportioning valve can render the sensor base and cleaning system universally adaptable to direct more cleaning fluid to any desired portion of the sensor in dependence of the mounted position.

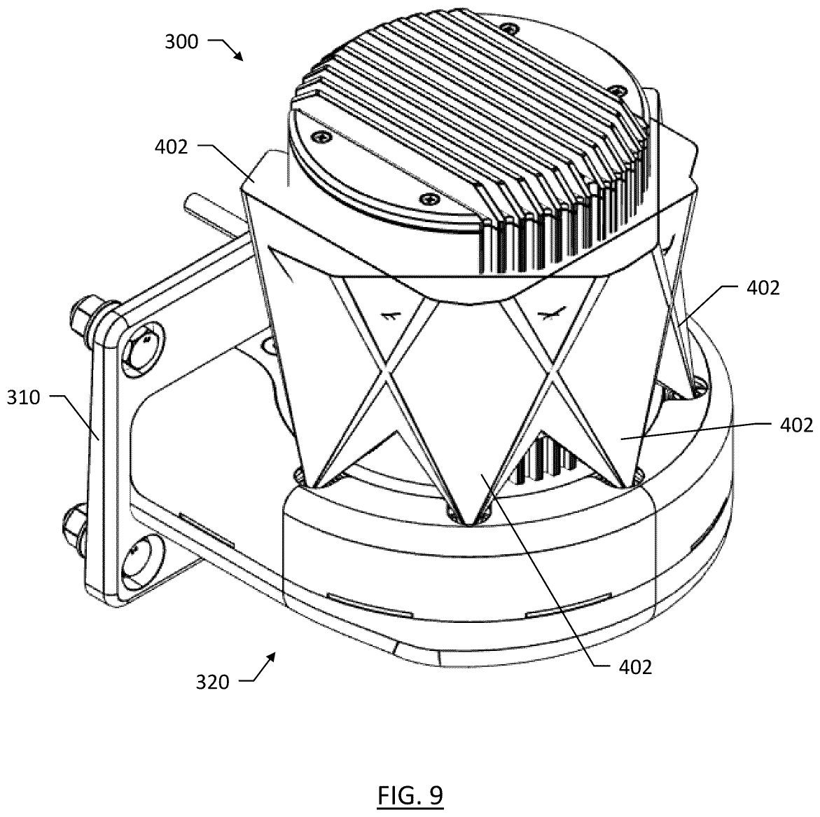

FIG. 9 illustrates the spray patterns 402 emanating from the nozzles 324 and impinging upon the sensor 300. With reference to FIGS. 7 and 9, the sensor includes a body having a top 304 that may include a heat sink as shown for dissipating heat. Below the top 304 of the sensor 300 is a sensor window 308. This sensor window 308 is the area through which the sensor observes the environment, such that the line-of-sight is defined through the sensor window 308. As such, it is imperative to keep clean the sensor window 308 to maintain operational efficiency and effectiveness of the sensor 300. The spray patterns 402 shown in FIG. 9 cover the sensor window 308 which is not visible in FIG. 9. The spray patterns 402 overlap by approximately one-third of the spray pattern at a top of the sensor window 308 to ensure complete coverage of the sensor window. Further, as the spray pattern 402 diverges as the distance from the nozzle 324 increases, there is less overlap at a bottom of the sensor window 308. The overlap proximate the top of the sensor window 308 is necessary to ensure complete coverage of the sensor window 308 proximate a bottom of the sensor window with the spray.

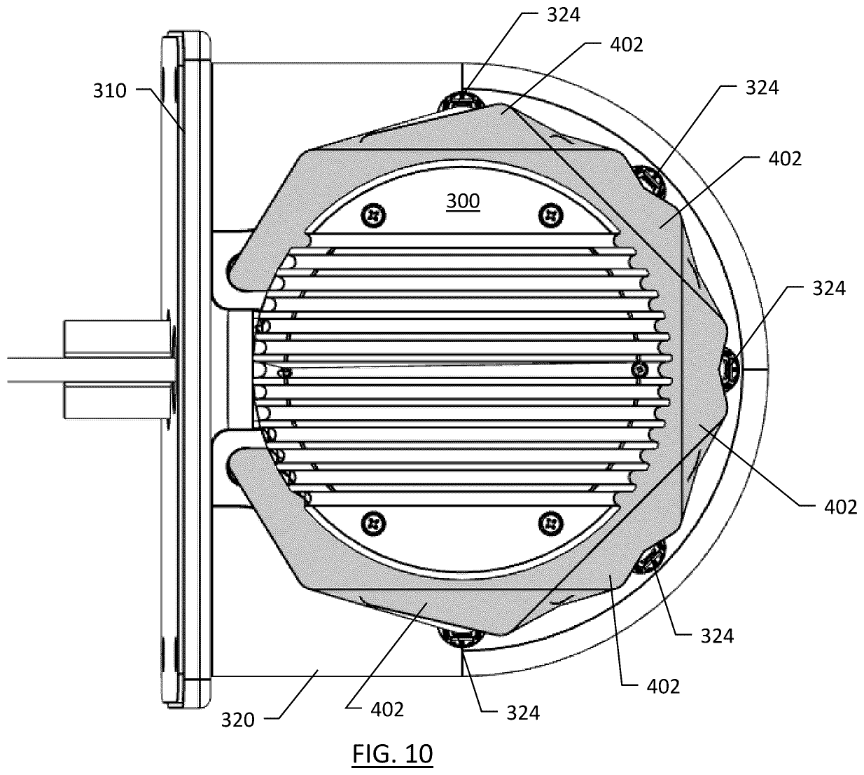

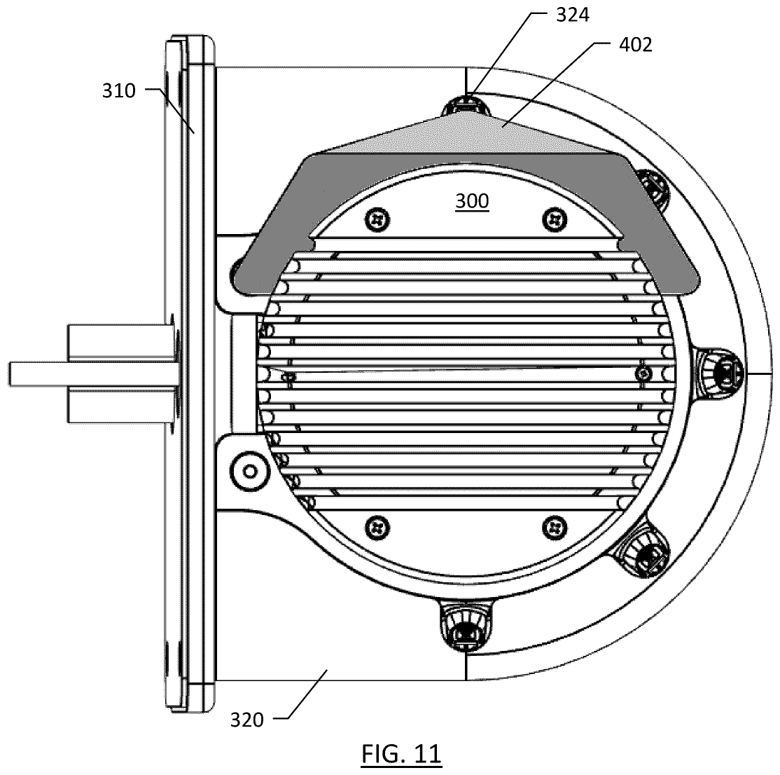

For most spray patterns generated from nozzles 324 similar to those shown in the figures, the spray patterns are most effective proximate a center of the spray pattern and closest to the nozzle. Thus, the overlapping at the edges of the spray patterns further from the nozzle helps to improve the effectiveness of the spray patterns at the edges through redundancy. FIG. 10 illustrates a top-view of the spray patterns 402 from each of the nozzles impinging upon the sensor 300. However, for clarity, FIG. 11 is provided with the same view as FIG. 10, but only depicting a single spray pattern 402 from a single nozzle 324. As shown, the spray pattern of the illustrated embodiment emanates from the nozzle 324 and covers more than 25% of a periphery of the sensor 300 proximate a top of the sensor window 308. This breadth of coverage, multiplied by five spray patterns from nozzles 324 distributed about only half of the periphery of the sensor leads to substantial coverage of the sensor window 308 for the field of view of the sensor 300.

The sensor base 320 is generally larger in diameter than the sensor 300 itself. However, it is desirable to substantially minimize a size of the sensor base 320. The sensor base 320 extending beyond the sensor provides additional risk for damage as the base may contact objects in the environment. However, with the sensor base housing the nozzles 324, it is necessary for the base to extend somewhat beyond a diameter of the sensor 300 itself. Embodiments described herein provide a nozzle arrangement that is capable of cleaning the sensor window 308 with a plurality of nozzles 324, where the nozzles are positioned relatively close to the sensor 300. The nozzles 324 are specifically selected to have a spray pattern that is effective from a close range and at a sharp angle with respect to the surface they are cleaning. As illustrated in the embodiments described herein, the nozzles 324 are generally within a distance of the sensor 300 that is no greater than a radius dimension of the sensor. This results in a sensor base 320 that is no greater than about twice a diameter of the sensor, providing a compact form-factor that is highly desirable for a system that extends away from an outside surface of a vehicle.

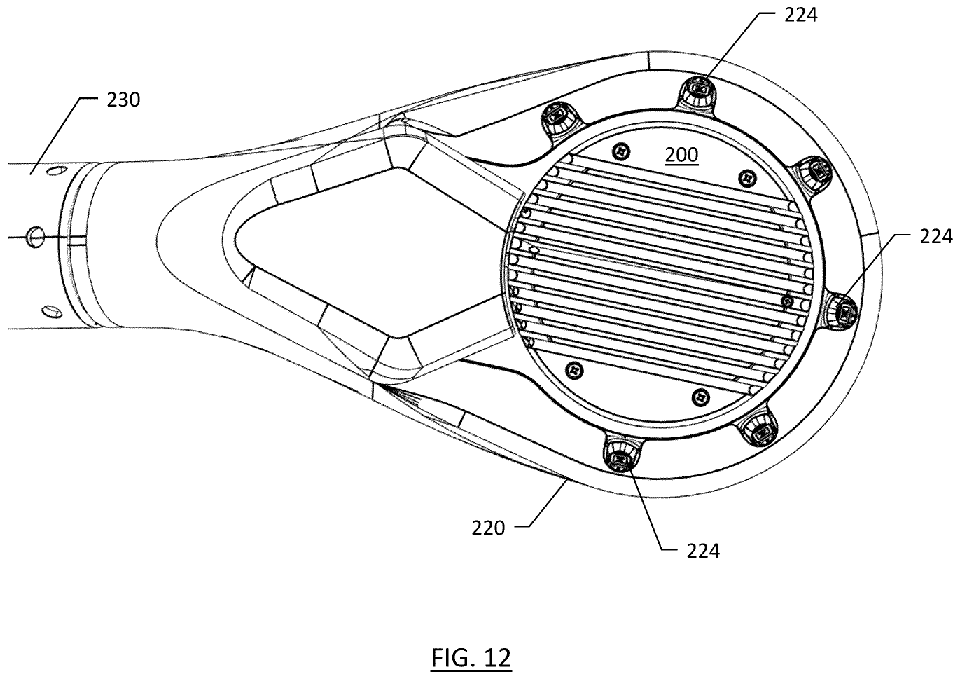

FIG. 12 illustrates the sensor 200 of the hood-mounted sensor with sensor base 220 and boom 230. As the hood-mounted sensor has a greater field of view, the number of nozzles 224 surrounding the sensor 200 is greater, and the spray patterns (not shown) from these nozzles would cover a greater portion of the periphery of the sensor to ensure the full field-of-view is kept clean and debris free.

The nozzles 224 of the hood-mounted sensor can be supplied by individual tubes as shown with respect to the side-mounted sensor in FIG. 8. These tubes can form a bundle that extends down through the boom 230 and through the mount 210 (shown in FIG. 6) where a manifold can connect the bundle of tubes to a supply from a fluid tank. This fluid tank can provide cleaning fluid to one or more of the two hood-mounted sensors and the two side-mounted sensors.

The sensor 200 of the above-described embodiments is vertically mounted and supported at its base. However, sensors may be configured to be mounted vertically while suspended from above, essentially inverted from the embodiments described above. In such an embodiment, the spray nozzles can be directed in a downward direction with similar spray pattern coverage as described above. In such an embodiment, with respect to the boom-mounted sensor, the boom may provide a blind-spot in the sensor field-of-view. As such, the diameter of the boom may be reduced to minimize such a blind spot. Reduction of the diameter of the boom may require a change to a material of the boom to meet the structural requirements of suspending the sensor from the boom while also being of a smaller diameter. Materials such as carbon fiber or aluminum can provide structural rigidity while remaining light weight.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

That which is claimed:

1. A system for cleaning a sensor housing comprising:
a sensor having a sensor window, wherein the sensor defines a field-of-view in a horizontal plane about the sensor;
a sensor base supporting the sensor thereon; and
a plurality of nozzles, wherein the plurality of nozzles are disposed within the sensor base, wherein each nozzle defines a spray pattern, and wherein the spray pattern from the plurality of nozzles is aimed upwardly and covers the sensor window about the field-of-view.

2. The system of claim 1, wherein the spray pattern for each nozzle expands as a distance from a respective nozzle increases, wherein the spray pattern from the plurality of nozzles covers the sensor window proximate a bottom of the sensor window about the field-of-view, and wherein the spray pattern from the plurality of nozzles overlaps a predetermined amount proximate a top of the sensor window about the field-of-view.

3. The system of claim 2, wherein the predetermined amount of overlap proximate the top of the sensor window about the field-of-view is about one-third of a first spray pattern overlapping an adjacent spray pattern.

4. The system of claim 1, wherein the field-of-view is between about 90-degrees and 330-degrees, wherein the plurality of nozzles are disposed about the sensor only about the field-of-view.

5. The system of claim 1, wherein the sensor base comprises a nozzle support and a cover, wherein the plurality of nozzles are received within the nozzle support, and wherein the nozzle support is covered by the cover.

6. The system of claim 5, wherein the sensor base further comprises a base frame, wherein the base frame supports the nozzle support and the cover.

7. The system of claim 6, further comprising a base plate, wherein the base plate is secured to the sensor and to the sensor base.

8. The system of claim 1, further comprising a tube bundle, wherein the tube bundle comprises a tube for each nozzle.

9. The system of claim 8, wherein tube bundle enters the sensor base through an aperture, and separates to supply each nozzle with fluid.

10. A method for cleaning a sensor housing comprising:
supporting a sensor on a sensor base, wherein the sensor comprises a sensor window and defines a field-of-view in a horizontal plane about the sensor; and
spraying the sensor window with a spray pattern from each of a plurality of nozzles, wherein the spray pattern from the plurality of nozzles is aimed upwardly from the sensor base and covers the sensor window about the field-of-view.

11. The method of claim 10, wherein the spray pattern from the plurality of nozzles covers the sensor window about the field-of-view proximate a bottom of the sensor window, the method further comprising:
configuring the spray pattern from adjacent nozzles of the plurality of nozzles to overlap by a predetermined amount proximate a top of the sensor window about the field-of-view.

12. The method of claim 11, wherein the predetermined amount of overlap proximate the top of the sensor window about the field-of-view is about one-third of a first spray pattern overlapping an adjacent spray pattern.

13. The method of claim 10, further comprising:
spacing the plurality of nozzles around the sensor to cover the field-of-view of the sensor, wherein the field-of-view of the sensor is less than 330-degrees.

14. The method of claim 10, further comprising:
supporting the plurality of nozzles on a nozzle support; and
surrounding the nozzle support with a cover.

15. The method of claim 14, further comprising:
mounting the nozzle support and cover to a sensor base

16. The method of claim 15, further comprising:
attaching the sensor to a base plate; and
attaching the base plate to the sensor base.

17. The method of claim 10, further comprising:
connecting each of the plurality of nozzles with a nozzle-specific tube of a tube bundle, wherein the tube bundle enters the sensor base through an aperture.

18. An apparatus for cleaning a sensor housing comprising:
a sensor base comprising:
a base frame;
a nozzle support carried by the base frame;
a plurality of nozzles received within the nozzle support; and
a cover supported by the base frame and covering the nozzle support; and
a sensor supported by the sensor base, wherein the sensor comprises a sensor window, wherein the sensor defines a field-of-view in a horizontal plane about the sensor, and wherein spray patterns from the plurality of nozzles are aimed upwardly and cover the sensor window about the field-of-view.

19. The apparatus of claim 18, wherein the plurality of nozzles are disposed about a base of the sensor, and wherein the plurality of nozzles are within a distance of the sensor that is less than a radius of the sensor.

20. The apparatus of claim 18, wherein a top of each of the plurality of nozzles is disposed below a bottom of the sensor.
